(19) United States
(12) Patent Application Publication
(10) Pub. No.: US 2019/0085718 A1
(43) Pub. Date: Mar. 21, 2019

(54) GAS TURBINE

(71) Applicant: DOOSAN HEAVY INDUSTRIES & CONSTRUCTION CO., LTD., Changwon-si (KR)

(72) Inventor: Yun Chang Jang, Gimhae-si (KR)

(21) Appl. No.: 16/004,428

(22) Filed: Jun. 11, 2018

(30) Foreign Application Priority Data
Sep. 15, 2017 (KR) 10-2017-0118374

(51) Int. Cl. F01D 25/12; F01D 9/04; F01D 5/14

(52) U.S. Cl. CPC F01D 25/12; F01D 9/041; F01D 5/143; F05D 2240/12; F05D 2260/20; F05D 2240/81; F05D 2250/241; F05D 2250/131; F05D 2220/32; F05D 2240/30

(57) ABSTRACT

A gas turbine includes an endwall supporting a vane or blade as a cooling object and having an airflow path through which cooling air is supplied to a leading edge of the cooling object; a curved portion disposed upstream of the leading edge to guide the cooling air supplied through the airflow path to the cooling object; and a guide protrusion formed on an upper surface of the endwall to redirect the movement of the cooling air to a side surface of the cooling object. The guide protrusion, disposed midway between the leading edge and a trailing edge of the cooling object, redirects the cooling air upward, higher along the side surface of the cooling object. A cooling channel formed in the endwall can be separately provided to supply cooling air to the leading edge of the cooling object, separately from the cooling air supplied through the airflow path.

### CROSS-REFERENCE TO RELATED APPLICATIONS

This application claims priority to Korean Patent Application No. 10-2017-0118374, filed on Sep. 15, 2018, the disclosure of which is incorporated herein by reference in its entirety.

### BACKGROUND OF THE DISCLOSURE

### Field of the Disclosure

The present disclosure relates to a gas turbine, and more particularly, to the guiding of cooling air in a gas turbine having a cooling object cooled by stably supplying part of the cooling air to the middle of a side surface of the cooling object.

### Description of the Related Art

Generally, a turbine is a machine converting the energy obtained by the fluid such as water, gas, and steam into a mechanical work, and is a turbo-type machine that generally installs several feathers or wings on the circumference of a rotating body and blows steam or gas thereon to rotate at a high speed with impulsive force or repulsive force.

The type of the turbine includes a hydro turbine using the energy of elevated water, a steam turbine using the energy of steam, an air turbine using the energy of high-pressure compressed air, a gas turbine using the energy of a high-temperature, high-pressure gas, etc.

Among them, the gas turbine includes a compressor, a combustor, a turbine, and a rotor.

The compressor includes a plurality of compressor vanes and a plurality of compressor blades that are alternatively located with each other.

The combustor generates a high-temperature, high-pressure combustion gas by supplying a fuel to the compressed air compressed in the compressor and igniting it with a burner.

The turbine includes a plurality of turbine vanes and a plurality of turbine blades that are alternatively located with each other.

The rotor is formed to penetrate the central portions of the compressor, the combustor, and the turbine, and has both end portions rotatably supported by a bearing and one end portion connected to a drive shaft of a generator.

Also, the rotor includes a plurality of compressor rotor disks fastened with the compressor blade, a plurality of turbine rotor disks fastened with the turbine blade, and a torque tube delivering a rotation force from the turbine rotor disk to the compressor rotor disk.

In the gas turbine in accordance with this configuration, the air compressed in the compressor is mixed with a fuel in the combustion chamber and combusted to be converted into a high-temperature combustion gas, the combustion gas thus produced is injected into the turbine side, the injected combustion gas generates the rotation force through the turbine blade, and the rotor is rotated.

It is advantageous that since the gas turbine has no reciprocating machinery such as a piston of a four-stroke engine, there is no mutual friction such as piston-cylinder, and thereby, the consumption of lubricant oil is extremely small, the amplitude that is the characteristic of the reciprocating machine is drastically reduced, and a high speed motion is possible.

The gas turbine having the above characteristics supplies, as an example, cooling air to cool a vane, which is subject to the heat of a high-temperature hot gas. The cooling air is mainly used in a surface cooling method in which cooling air is injected from a hole formed in an endwall supporting the vane.

Conventionally, the surface cooling of the vane has been carried out mainly at or near (above) the hub, which is adjacent to the endwall. In this case, there is a problem in that cooling is unstably performed as the effective point of cooling moves higher up the vane to the tip and in that heat-related stress is concentrated. Accordingly, countermeasures for the above have been required.

### SUMMARY OF THE DISCLOSURE

Exemplary embodiments of the present disclosure provide a gas turbine which guides the movement direction of a cooling air supplied to the surface of a vane or a blade of the gas turbine to a certain position, thus enhancing cooling efficiency.

A gas turbine in accordance with a first embodiment of the present disclosure includes an endwall supporting a cooling object and having an airflow path through which cooling air is supplied to a leading edge of the cooling object; a curved portion disposed upstream of the leading edge to guide the cooling air supplied through the airflow path to the cooling object; and a guide protrusion formed on an upper surface of the endwall to redirect the movement of the cooling air to a side surface of the cooling object.

The cooling object may include either one of a vane and a blade provided in the gas turbine.

The airflow path may be inclined toward the cooling object.

The curved portion may have a lateral width greater than a lateral width of the cooling object.

The curved portion may include a curve based on a first length and a second length, where the second length corresponds to a vertical length extending from the upper surface of the endwall to a perpendicular extending from a first end of the curve, and the first length is greater than the second length and corresponds to a longitudinal length extending from the first end of the curve toward the cooling object and ending at a perpendicular extending from a second end of the curve.

The guide protrusion may be disposed in correspondence to a middle section between the leading edge and a trailing edge of the cooling object.

The cooling object may include a suction surface and a pressure surface, and the guide protrusion is respectively disposed adjacent to the suction surface and the pressure surface.

The guide protrusion may be formed to have one of a hemispheric shape and a polygonal shape.

The guide protrusion may include a protruded surface having a predetermined width and a predetermined height protruding from the upper surface of the endwall.

The endwall may include an air guiding surface disposed upstream of the guide protrusion and upwardly inclined toward the guide protrusion in order to guide the cooling air toward a crest of the guide protrusion.

The cooling object includes a hub and a tip separated by a span S, and the guide protrusion redirects the cooling air toward an S/2 location of the side surface of the cooling object.

A gas turbine in accordance with a second embodiment of the present disclosure includes the endwall, the curved portion, the guide protrusion; and a cooling channel formed in the endwall to supply cooling air to the leading edge of the cooling object, separately from the cooling air supplied through the airflow path.

The cooling channel may have an inner diameter whose one end communicates with the airflow path formed larger than an inner diameter of the other end connected with the endwall.

The cooling channel may communicate at one end with the airflow path and at the other end with the endwall and have a diameter that is constant from the airflow path to the endwall. Alternatively, the cooling channel may have a diameter that is larger than a diameter of the airflow path.

The cooling channel may have a diameter that is reduced from the airflow path toward the endwall.

The cooling channel may include an endwall end having a shape of either of a straight line and a curved line.

The cooling channel may include a groove portion of a spiral shape formed on an inside surface.

The cooling channel may include a first channel having a first length; and a second channel extending from the first channel and having a rounded end toward the upper surface of the endwall. The first channel may be longer than the second channel.

In the embodiments of the present disclosure, it is possible to enhance the surface cooling efficiency for the vane of a gas turbine, thus minimizing the deformation occurrence due to localized heat stress. It is further possible to redirect the cooling air to a midway point of the span of the vane, thus achieving enhanced durability for long-time usage through the cooling efficiency enhancement.

### BRIEF DESCRIPTION OF THE DRAWINGS

FIG. 1 is a cross-sectional view of a gas turbine according to the present disclosure.

FIG. 2 is a perspective view of an endwall supporting a cooling object of the gas turbine in accordance with a first embodiment of the present disclosure, illustrating a guide protrusion and an airflow path.

FIG. 3 is a side view of the gas turbine shown in FIG. 2.

FIG. 4 is a perspective view of the guide protrusion shown in FIG. 2.

FIG. 5 is a side view of the guide protrusion shown in FIG. 4.

FIGS. 6 to 9 are schematic side views of an endwall supporting a cooling object of the gas turbine in accordance with a second embodiment of the present disclosure, respectively illustrating configurations of a cooling channel.

### DESCRIPTION OF SPECIFIC EMBODIMENTS

A configuration of a gas turbine in accordance with a first embodiment of the present disclosure will be described with reference to the drawings.

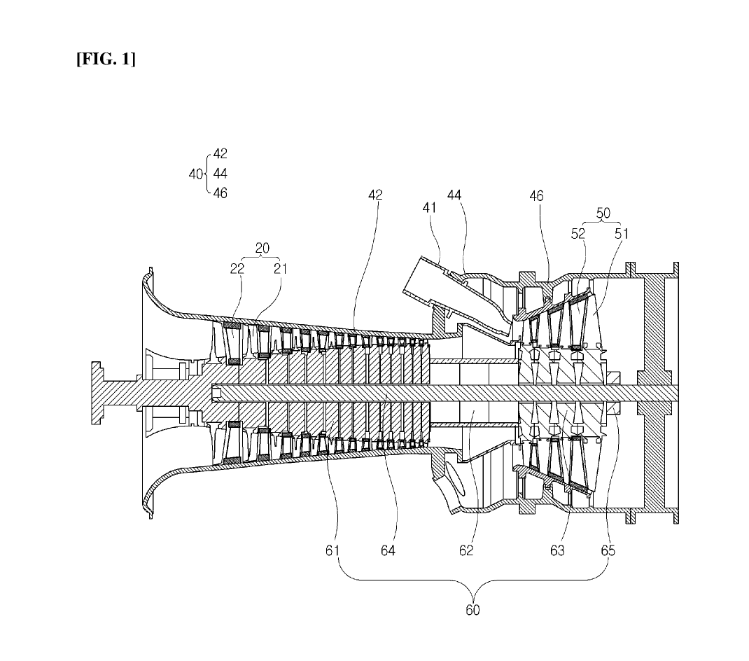

Referring to FIG. 1, a gas turbine in accordance with the present embodiment is provided with a housing 40, a rotor 60 rotatably provided inside the housing 40, and a compressor 20 compressing an air flowed into the housing 40 by receiving a rotation force from the rotor 60.

And, it includes a combustor 41 generating a combustion gas by mixing a fuel with the air compressed in the compressor 20 and igniting it, a turbine 50 rotating the rotor 60 by obtaining the rotation force from the combustion gas generated from the combustor 41, a generator interlocking to the rotor 60 for power generation, and a diffuser discharging the combustion gas through the turbine 50.

The housing 40 includes a compressor housing 42 receiving the compressor 20, a combustor housing 44 receiving the combustor 41, and a turbine housing 46 receiving the turbine 50.

The compressor housing 42, the combustor housing 44, and the turbine housing 46 are sequentially arranged from the upstream side to the downstream side in the fluid flow direction.

The rotor 60 includes a compressor rotor disk 61 received in the compressor housing 42, a turbine rotor disk 63 received in the turbine housing 46, a torque tube 62 received in the combustor housing 44 and connecting the compressor rotor disk 61 and the turbine rotor disk 63, and a tie rod 64 and a fixing nut 65 fastening the compressor rotor disk 61, the torque tube 62, and the turbine rotor disk 63.

The compressor rotor disk 61 is formed in plural, and the plurality of compressor rotor disks 61 are arranged along the shaft direction of the rotor 60. As an example, the compressor rotor disk 61 can be formed in multiple stages.

And, each compressor rotor disk 61 is, as an example, formed in a disc shape, and has a compressor blade connection slot connected with the compressor blade 21 that will be described later formed on the outer circumferential portion thereof.

The compressor blade connection slot can be in a fir-tree shape so that the compressor blade 21 that will be described later is not deviated from the compressor blade connection slot in the rotation radial direction of the rotor 60.

The compressor rotor disk 61 and the compressor blade 21 that will be described later are generally connected in the tangential type or the axial type.

The present embodiment is formed to be connected in the axial type, the compressor blade connection slot is formed in plural, and the plurality of compressor blade connection slots can be radially arranged along the circumferential direction of the compressor rotor disk 61.

The turbine rotor disk 63 can be formed similar to the compressor rotor disk 61. The turbine rotor disk 63 is formed in plural, and the plurality of the turbine rotor disks 63 can be arranged along the shaft direction of the rotor 60. As an example, the turbine rotor disk 63 can be formed in multiple stages.

And, each turbine rotor disk 63 is formed substantially in the disc shape, and the turbine blade connection slot connected with the turbine blade 51 that will be described later can be formed on the outer circumferential portion thereof.

The turbine blade connection slot can be formed in the fir-tree shape to prevent the turbine blade 51 that will be described later from deviating from the turbine blade connection slot in the rotation radial direction of the rotor 60.

Herein, the turbine rotor disk 63 and the turbine blade 51 that will be described later are generally connected in the tangential type or the axial type, and in the present embodiment, are formed to be connected in the axial type. Accordingly, the turbine blade connection slot in accordance with the present embodiment is formed in plural, and the plurality of the turbine blade connection slots can be radially arranged along the circumferential direction of the turbine rotor disk 63.

The torque tube 62 is a torque delivery member delivering the rotation force of the turbine rotor disk 63 to the compressor rotor disk 61, and has one end portion fastened with the compressor rotor disk 61 located at the most downstream end in the flow direction of the air among the plurality of compressor rotor disks 61 and the other end portion fastened with the turbine rotor disk 63 located at the most upstream end in the flow direction of the combustion gas among the plurality of turbine rotor disks 63.

The torque tube 62 has a protrusion formed on one end portion and the other end portion thereof, and each of the compressor rotor disk 61 and the turbine rotor disk 63 is formed with a groove engaged with the protrusion to prevent the torque tube 62 from performing the relative rotation to the compressor rotor disk 61 and the turbine rotor disk 63.

The torque tube 62 is formed in the hollow-type cylinder shape so that the air supplied from the compressor 20 can be flowed into the turbine 50 through the torque tube 62.

And, the torque tube 62 is formed to be resistant to deformation, twist, etc. due to the characteristics of the gas turbine continuously operated for a long time, and can be formed to be easily assembled and disassembled for easy maintenance.

The tie rod 64 is formed to penetrate the plurality of compressor rotor disks 61, the torque tube 62, and the plurality of the turbine rotor disks 63, and has one end portion fastened in the compressor rotor disk 61 located at the most upstream end in the flow direction of the air among the plurality of compressor rotor disks 61 and the other end portion protruded in the opposite side of the compressor 20 based on the turbine rotor disk 63 located at the most downstream end in the flow direction of the combustion gas among the plurality of the turbine rotor disks 63 and fastened with the fixing nut 65.

Herein, the fixing nut 65 is provided in order to pressurize the turbine rotor disk 63 located at the most downstream end to the compressor 20 side.

In addition, as an interval between the compressor rotor disk 61 located at the most upstream end and the turbine rotor disk 63 located at the most downstream end is reduced, the plurality of compressor rotor disks 61, the torque tube 62, and the plurality of turbine rotor disks 63 can be compressed in the shaft direction of the rotor 60.

Accordingly, the shaft directional movement and the relative rotation of the plurality of compressor rotor disks 61, the torque tube 62, and the plurality of turbine rotor disks 63 can be prevented.

Meanwhile, in the present embodiment, one tie rod 64 is formed to penetrate the central portions of the plurality of compressor rotor disks 61, the torque tube 62, and the plurality of turbine rotor disks 63, but is not limited thereto.

That is, a separate tie rod 64 can be provided at the compressor 20 side and the turbine 50 side, respectively, and the plurality of tie rods 64 can be also radially located along the circumferential direction thereof and a combination of thereof is also possible.

The rotor 60 in accordance with this configuration has both end portions rotatably supported by a bearing 700 and one end portion connected to a drive shaft of the generator.

The compressor 20 can include a compressor vane 22 fixedly installed to the housing 100 in order to align the compressor blade 21 rotated with the rotor 60 and the air flow flowed into the compressor blade 21.

The compressor blade 21 is formed in plural, the plurality of compressor blades 21 are formed along the shaft direction of the rotor 60 in multiple stages, and the plurality of compressor blades 21 can be radially formed along the rotation direction of the rotor 60 for each stage.

And, each compressor blade 21 can include a plate-type compressor blade platform portion, a compressor blade root portion extended from the compressor blade platform portion to the core side in the rotation radial direction of the rotor 60, and a compressor blade airfoil portion extended from the compressor blade platform portion to the centrifugal side in the rotation radial direction of the rotor 60.

The compressor blade platform portion contacts with a neighboring compressor blade platform portion and can function as maintaining the interval between the compressor blade airfoil portions.

The compressor blade root portion can, as described above, be formed in so-called axial-type shape inserted along the shaft direction of the rotor 60 into the compressor blade connection slot.

And, the compressor blade root portion can be formed in the fir-tree shape in order to correspond to the compressor blade connection slot.

In the present embodiment, the compressor blade root portion and the compressor blade connection slot are formed in the fir-tree shape, but are not limited thereto, and can be also formed in the dovetail shape. Or, using another fastener other than the shapes, for example, a fixture such as a key or a bolt, the compressor blade 21 can be fastened to the compressor rotor disk 61.

And, in order to easily fasten the compressor blade root portion and the compressor blade connection slot, the compressor blade connection slot is formed larger than the compressor blade root portion, and in the connected state, a gap between the compressor blade root portion and the compressor blade connection slot can be formed.

Although not shown separately, the compressor blade root portion and the compressor blade connection slot can be fixed by a separate pin to prevent the compressor blade root portion from deviating from the compressor blade connection slot in the shaft direction of the rotor 60.

The compressor blade airfoil portion is formed to have an optimized airfoil depending upon the gas turbine specification, and can include a leading edge located at the upstream side in the flow direction of the air to contact with the air, and a trailing edge located at the downstream side in the flow direction of the air to contact with the air.

The compressor vane 22 is formed in plural, and the plurality of compressor vanes 22 can be formed along the shaft direction of the rotor 60 in multiple stages. Herein, the compressor vane 22 and the compressor blade 21 can be alternatively arranged with each other along the air flow direction.

And, the plurality of compressor vanes 22 can be radially formed along the rotation direction of the rotor 60 for each stage.

And, each compressor vane 22 can include a compressor vane platform portion formed in the annular shape along the rotation direction of the rotor 60, and a compressor vane airfoil portion extended from the compressor vane platform portion in the rotation radial direction of the rotor 60.

The compressor vane platform portion is formed at the wing-root portion of the compressor vane airfoil portion, and can include a tip-side compressor vane platform portion formed at the root-side the compressor vane platform portion fastened to the compressor housing 42 and the wingtip portion of the compressor vane airfoil portion and opposite to the rotor 60.

The compressor vane platform portion in accordance with the present embodiment includes the root-side compressor vane platform portion and the tip-side compressor vane platform portion in order to more stably support the compressor vane airfoil portion by supporting the wingtip portion as well as the wingroot portion of the compressor vane airfoil portion, but is not limited thereto.

That is, the compressor vane platform portion includes the root-side compressor vane platform portion and can be also formed to support only the wingroot portion of the compressor vane airfoil portion.

The compressor vane airfoil portion is formed to have an optimized airfoil depending the gas turbine specification, and can include a leading edge located at the upstream side in the flow direction of the air to contact with the air and a trailing edge located at the downstream side in the flow direction of the air to contact with the air.

The combustor 41 produces a high-temperature, high-pressure combustion gas of a high energy by mixing a fuel with the air flowed from the compressor 20 and combusting it, and in the constant pressure combustion process, can be formed to increase the combustion gas temperature up to the heat-resistance limitation that the combustor 41 and the turbine 50 can endure.

The combustor 41 is formed in plural, and the plurality of combustors 41 can be arranged in the combustor housing 44 along the rotation direction of the rotor 60.

And, each combustor 41 can include a liner into which the air compressed in the compressor 20 is flowed, a burner injecting a fuel to the air flowed in the liner and combusting it, and a transition piece guiding the combustion gas generated in the burner to the turbine 50.

The liner can include a flame barrel forming the combustion chamber and a flow sleeve forming an annular space while surrounding the flame barrel.

The burner can include a fuel inject nozzle formed at the front end side of the liner in order to inject the fuel to the air flowed into a combustion chamber, and an ignition plug formed at a wall portion of the liner in order to ignite the air and the fuel mixed in the combustion chamber.

The outer wall portion of the transition piece can be formed to be cooled by the air supplied from the compressor 20 so that the transition piece is not damaged by a high temperature of the combustion gas.

The transition piece is formed with a cooling hole for injecting the air into the inside thereof, and the air can cool the internal body through the cooling hole.

The air cooling the transition piece is flowed into the annular space of the liner, and the air from the outside of the flow sleeve is supplied to the outside wall of the liner as the cooling air through the cooling hole prepared in the flow sleeve, thereby causing collision.

Although not shown separately, a desworler functioning as a guide feather in order to adjust the flow angle of the air flowed into the combustor 41 to a design flow angle can be formed between the compressor 20 and the combustor 41.

The turbine 50 can be also formed similar to the compressor 20.

That is, the turbine 50 can include a turbine blade 51 rotated with the rotor 60, and a turbine vane 52 fixedly installed in the housing 100 in order to align the air flow flowed into the turbine blade 51.

The turbine blade 51 is formed in plural, the plurality of turbine blades 51 are formed along the shaft direction of the rotor 60 in multiple stages, and the plurality of turbine blades 51 can be radially formed along the rotation direction of the rotor 60 for each stage.

Each turbine blade 51 can include a plate-type turbine blade platform portion, a turbine blade root portion extended from the turbine blade platform portion to the core side in the rotation radial direction of the rotor 60, and a turbine blade airfoil portion extended from the turbine blade platform portion to the centrifugal side in the rotation radial direction of the rotor 60.

The turbine blade platform portion can contact with a neighboring turbine blade platform portion and function as maintaining the interval between the turbine blade airfoil portions.

The turbine blade root portion can, as described above, be formed in the so-called axial type shape inserted into the turbine blade connection slot along the shaft direction of the rotor 60.

And, the turbine blade root portion can be formed in the fir-tree shape in order to correspond to the turbine blade connection slot.

In the present embodiment, the turbine blade root portion and the turbine blade connection slot are formed in the fir-tree shape, but are not limited thereto and can be also formed in the dovetail shape.

Or, using another fastener other than the above shapes, for example, a fixture such as a key or a bolt, the turbine blade 51 can be fastened to the turbine rotor disk 63.

And, in order to easily fasten the turbine blade root portion and the turbine blade connection slot, the turbine blade connection slot is formed larger than the turbine blade root portion.

In addition, in the connected state, a gap between the turbine blade root portion and the turbine blade connection slot can be formed.

And, although not shown separately, the turbine blade root portion and the turbine blade connection slot are fixed by a separate pin to prevent the turbine blade root portion from deviating from the turbine blade connection slot in the shaft direction of the rotor 60.

The turbine blade airfoil portion is formed to have an optimized airfoil depending upon the gas turbine specification, and can include a leading edge located at the upstream side in the flow direction of the combustion gas and into which the combustion gas is flowed, and a trailing edge located at the downstream side in the flow direction of the combustion gas and into which the combustion gas is discharged.

The turbine vane 52 is formed in plural, the plurality of turbine vanes 52 can be formed along the shaft direction of the rotor 60 in multiple stages. Herein, the turbine vane 52 and the turbine blade 51 can be alternatively arranged with each other along the air flow direction.

And, the plurality of turbine vanes 52 can be radially formed along the rotation direction of the rotor 60 for each stage.

Each turbine vane 52 can include a turbine vane platform portion formed in an annular shape along the rotation direction of the rotor 60, and a turbine vane airfoil portion extended from the turbine vane platform portion in the rotation radial direction of the rotor 60.

The turbine vane platform portion can include a root-side turbine vane platform portion formed at the wingroot portion of the turbine vane airfoil portion and fastened to the turbine housing 46, and a tip-side turbine vane platform portion formed at the wingtip portion of the turbine vane airfoil portion and opposite to the rotor 60.

The turbine vane platform portion in accordance with the present embodiment includes the root-side turbine vane platform portion and the tip-side turbine vane platform portion in order to more stably support the turbine vane airfoil portion by supporting the wingroot portion as well as the wingtip portion of the turbine vane airfoil portion, but is not limited thereto.

That is, the turbine vane platform portion includes the root-side turbine vane platform portion and can be also formed to support only the wingroot portion of the turbine vane airfoil portion.

The turbine vane airfoil portion is formed to have an optimized airfoil depending the gas turbine specification, and can include a leading edge located at the upstream side in the flow direction of the combustion gas and into which the combustion gas is flowed and a trailing edge located at the downstream side in the flow direction of the combustion gas and into which the combustion gas is discharged.

The turbine 50 contacts a high-temperature, high-pressure combustion gas of a high energy unlike the compressor 20, such that the cooling means for preventing the damage such as deterioration is required.

The gas turbine in accordance with the present embodiment can further include a cooling flow path adding the air compressed at some places of the compressor 20 and supplying it to the turbine 50.

The cooling flow path is extended from the outside of the housing 100 (external flow path), or can be extended by penetrating the inside of the rotor 60 (internal flow path), or also use all of the external flow path and the internal flow path.

The cooling flow path can be connected with a turbine blade cooling flow path formed inside the turbine blade 51 to cool the turbine blade 51 by the cooling air.

The turbine blade cooling flow path can be connected with a turbine blade film cooling hole formed on the surface of the turbine blade 51 to supply the cooling air to the surface of the turbine blade 51, thus performing so-called film cooling for the turbine blade 51 by the cooling air.

In addition, the turbine vane 52 can be also formed to be cooled by receiving the cooling air from the cooling flow path similar to the turbine blade 51.

Meanwhile, the turbine 50 needs a gap between the wingtip of the turbine blade 51 and the inner circumferential surface of the turbine housing 46 so that the turbine blade 51 can be smoothly rotated.

However, the wider the gap is, the more advantageous in terms of the interference prevention between the turbine blade 51 and the turbine housing 46 but it is disadvantageous in terms of leakage of the combustion gas, and the narrower is the opposite.

That is, the flow of the combustion gas injected from the combustor 41 can be divided into a main flow passing through the turbine blade 51 and a leakage flow passing through the gap between the turbine blade 51 and the turbine housing 46, and as the gap is wider, the leakage flow increases and the gas turbine efficiency decreases, but the interference between the turbine blade 51 and the turbine housing 46 due to heat deformation, etc. and damage caused by it can be prevented.

On the other hand, as the gap is narrower, the leakage flow is reduced to enhance the gas turbine efficiency, but the interference between the turbine blade 51 and the turbine housing 46 due to heat deformation, etc. and damage caused by it can be occurred.

The gas turbine in accordance with the present embodiment can further include a sealing means in order to secure a proper gap that can minimize the deterioration of the gas turbine efficiency while preventing the interference between the turbine blade 51 and the turbine housing 46 and the damage caused by it.

The sealing means can include a shroud located at the wingtip of the turbine blade 51, a labyrinth seal protruded in the centrifugal side from the shroud in the rotation radial direction of the rotor 60, and a honeycomb seal installed on the inner circumferential surface of the turbine housing 46.

The sealing means in accordance with this configuration is formed with a proper gap between the labyrinth seal and the honeycomb seal to prevent a direct contact between the shroud rotated at a high speed and the fixed honeycomb seal and the damage caused by it while minimizing the deterioration of the gas turbine efficiency due to the leakage of the combustion gas.

The turbine 50 can further include a sealing means for blocking the leakage between the turbine vane 52 and the rotor 60, and it can use a brush seal, etc. in addition to the above-described labyrinth seal.

In the gas turbine in accordance with this configuration, the air flowed into the housing 100 is compressed by the compressor 20, the air compressed by the compressor 20 is mixed with a fuel by the combustor 41 and then combusted to become a combustion gas, and the combustion gas generated in the combustor 41 is flowed into the turbine 50.

The combustion gas flowed in the turbine 50 rotates the rotor 60 through the turbine blade 51 and then discharged into the atmosphere through the diffuser, and the rotor 60 rotated by the combustion gas can operate the compressor 20 and the generator.

That is, a part of the mechanical energies obtained in the turbine 50 are supplied as the energy required for compressing the air in the compressor 20, and the rest can be used to produce the power by the generator.

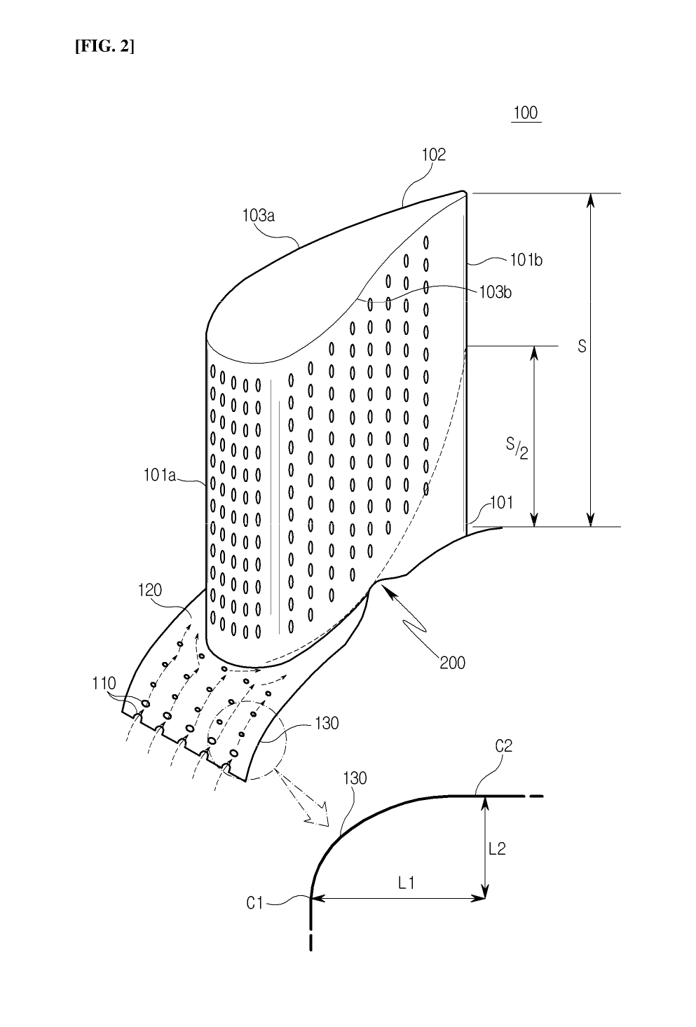

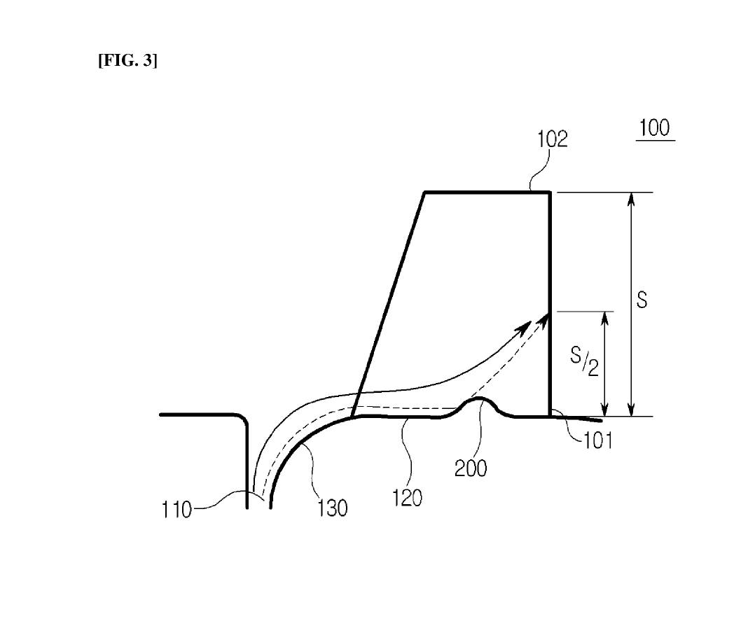

Referring to FIGS. 2 to 4, the gas turbine in accordance with a first embodiment of the present disclosure includes a cooling object 100 disposed on an endwall 120 on which is formed an airflow path 110 into which cooling air is injected, a curved portion 130 for guiding the cooling air supplied through the airflow path 110 from the front location of a leading edge 101a formed on the cooling object 100 to the cooling object 100, and a guide protrusion 200 spaced to the side surface of the cooling object 100 to be located on the upper surface of the endwall 120 and guiding the movement direction of the cooling air. Accordingly, the endwall 120 supports the cooling object 100, the curved portion 130 is disposed upstream of the leading edge 101a.

The airflow path 110 is disposed upstream of the leading edge 101a and serves to receive an injection of cooling air to be supplied to the cooling object 100. As shown in the drawings, the airflow path 110 includes a plurality of such paths provided across a surface of the curved portion 130 in order to introduce the injected cooling air to the cooling object 100.

Though the present embodiment describes the cooling object 100 as a vane, a cooling object 100 in accordance with the present embodiment may be a vane, blade, or similar component provided in a gas turbine as an object that is air-cooled.

The present embodiment supplies the cooling air supplied to the vane that is the cooling object 100 to the S/2 location of the span S) extended from a hub 101 to a tip 102 of the cooling object 100 to enhance the cooling performance.

For reference, in the cooling object 100, the location adjacent to the endwall 120 corresponds to the hub 101 and the end portion extended to the outside corresponds to the tip 102.

The span S corresponds to the vertical dimension of the cooling object 100, the present embodiment moves the cooling air to the middle location of the span S to enhance the cooling performance, thus simultaneously achieving the enhancement of the operation stability and the efficiency of the turbine.

In addition, the cooling object 100 has the leading edge 101a formed on the front end portion thereof and the trailing edge 101b formed on the rear end portion thereof.

And, the endwall 120 is the structure supporting the lower end of the cooling object 100 based on the drawing, and is configured to have a predetermined thickness.

If the cooling air is supplied to the cooling object 100 through the airflow path 110, the surface cooling is performed.

In order to solve the problem that the cooling air is supplied only to the hub 101 or the location adjacent to the hub 101, the present embodiment can easily supply it to the middle location of the span S of the cooling object 100 from the hub 101.

In this case, the cooling object 100 stably performs the cooling up to the S/2 location corresponding to the middle thereof from the hub 101, thus enhancing the cooling efficiency of the cooling object 100.

In order to guide, as described above, the movement direction of the cooling air supplied to the cooling object 100 through the airflow path 110, the present embodiment is provided with the curved portion 130 and the guide protrusion 200.

The curved portion 130 guides the initial direction that the cooling air is injected on the cooling object 100 through the airflow path 110, as illustrated in the drawing.

The airflow path 110 is formed in plural at the front of the cooling object 100, and if the cooling air is simultaneously supplied to the S/2 location of the cooling object 100 in each airflow path 110, the cooling efficiency of the cooling object 100 due to a hot gas can be enhanced.

It is advantageous that the curved portion 130 in accordance with the present embodiment supplies a part of the cooling air injected from the plurality of airflow paths 110 described above to the hub 101 of the cooling object 100, and the rest can supply it to the S/2 location of the cooling object 100, thus diffusing and supplying the supply direction of the cooling air more than the convention.

Since the airflow path 110 in accordance with the present embodiment is located to be inclined toward the cooling object, the inclination angle intersecting with the curved portion 130 is maintained at the angle of 90 degree or less.

In this case, the cooling air can be more easily moved to the right side based on the drawing, and thus can be moved to the location of the guide protrusion 200 that will described later.

The curved portion 130 in accordance with the present embodiment is extended longer than a lateral directional width of the cooling object 100. The cooling object 100 is the airfoil shape so formed in the elliptical shape as seen at the top thereof.

And, the curved portion 130 is extended by a predetermined width as seen at the top thereof, and the width is extended relatively longer than the lateral directional width of the cooling object 100.

If the curved portion 130 is thus configured, the cooling air can constantly supply the cooling air of the amount that can cover the entire cooling objects 100. Accordingly, the cooling object 100 enhances the cooling efficiency by the cooling air through the curved portion 130.

The curved portion 130 in accordance with the present embodiment is formed with a first length L1 corresponding to the length extended in the lateral direction toward the cooling object 100 based on the movement direction of the cooling air among the entire extension paths extended toward the cooling object 100, and a second length L2 corresponding to the extended length toward the upper surface of the endwall 120 from the extended end portion of the first length L1, and the first length L1 is extended longer than the second length L2. In other words, the curved portion 130 includes a curve based on the first length L1 and the second length L2. The second length L2 corresponds to a vertical length extending from the upper surface of the endwall 120 to a perpendicular extending from a first end C1 of the curve, and the first length L1 is greater than the second length L2 and corresponds to a longitudinal length extending from the first end C1 of the curve toward the cooling object 10 and ending at a perpendicular extending from a second end C2 of the curve.

The first length L1 corresponds to the length rounded to the upside thereof, and the second length L2 corresponds to the height of the curved portion 130.

The long length of the first length L1 prevents a separation phenomenon of the cooling air from the surface, such that the cooling air is stably moved toward the cooling object 100 along the surface of the curved portion 130.

The guide protrusion 200 in accordance with the present embodiment is located in a middle section, substantially halfway between the leading edge 101a and the trailing edge 101b of the cooling object 100. The guide protrusion 200 can stably guide the movement direction of the cooling air to the S/2 location of the span S from the location described above.

The direction of the cooling air is changed one time by the guide protrusion 200 through the cooling object 100, and the S/2 location corresponds to the most advantageous location for changing the movement direction of the cooling air.

For example, if the guide protrusion 200 is located closer to the leading edge 101a side than the above-described location, or moved to the trailing edge 101b side, the movement direction of the cooling air cannot be moved to the middle location of the cooling object, such that it is preferable to locate the guide protrusion 200 at the location described above.

The guide protrusion 200 is formed in any one shape of the hemispheric shape or the polygonal shape. In addition, the guide protrusion 200 can be also changed into different shapes in addition to the above-described shapes in order to induce a stable movement of the cooling air.

The guide protrusion 200 in accordance with the present embodiment is located adjacent to the suction surface 103a and the pressure surface 103b formed on the cooling object 100. The location corresponds to the optimum location that the cooling air is supplied to the surface of the cooling object 100 through the guide protrusion 200.

If the guide protrusion 200 is located away from the suction surface 103a and the pressure surface 103b, the movement of the cooling air to the surface of the cooling object 100 can be disadvantageous, such that the guide protrusion 200 is located at the above-described location.

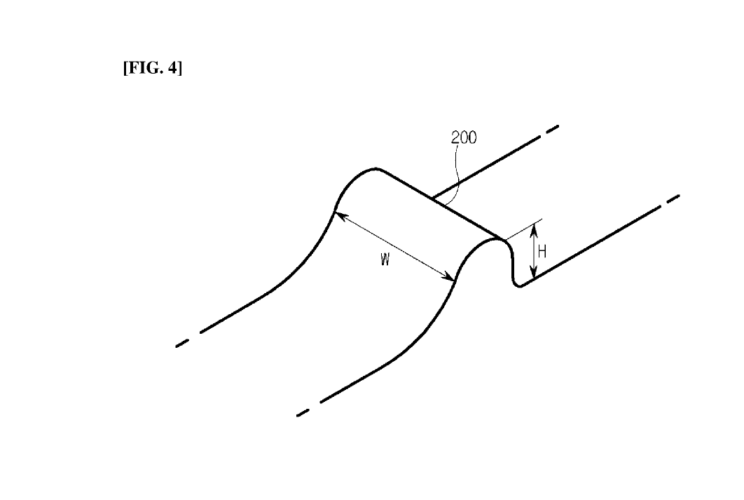

Referring to FIG. 4, the guide protrusion 200 is extended to have the width (W) having a predetermined length in the lateral direction after upwardly protruded from the upper surface of the endwall 120 as seen at the front on which the leading edge 101a of the cooling object 100 is formed, and as seen at the side surface thereof, is upwardly protruded to have a predetermined height (H) from the upper surface of the endwall 120.

The present embodiment corresponds to the case that the guide protrusion 200 is configured to have the predetermined lateral width and height other than the hemispheric shape or the polygonal shape.

In this case, the cooling air moves along the surface of the endwall 120, is then induced in the upward movement direction by the guide protrusion 200, and eventually moved to the middle location of the surface of the cooling object 100.

Accordingly, the cooling air can stably reach the side surface of the cooling object 100, thus enhancing the cooling efficiency.

In another embodiment, the guide protrusion 200 can be configured to be inclined at a predetermined angle toward the suction surface 103a and the pressure surface 103b of the cooling object 100 while maintaining the configuration of the above-described embodiment as it is.

In this case, the cooling air moves along the surface of the endwall and then the movement direction thereof can be easily changed toward the suction surface 103a and the pressure surface 103b of the cooling object 100.

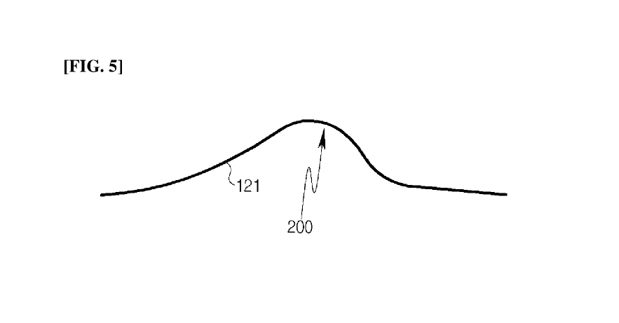

Referring to FIG. 5, the endwall 120 is formed with an air guiding surface 121 upwardly inclined toward the guide protrusion 200 from the front of the guide protrusion 200 in order to guide the movement direction of the cooling air to the rounded surface of the guide protrusion 200.

The air guiding surface 121 can more easily move to the side surface of the cooling object 100 by inducing to the upper height of the guide protrusion 200 before the cooling air contacts with the guide protrusion 200.

In addition, when configured as above, the cooling air can stably reach the S/2 location without an energy loss or separation phenomenon.

A gas turbine in accordance with a second embodiment of the present disclosure will be described with reference to the drawings, in which description of elements corresponding to those of the first embodiment will be omitted.

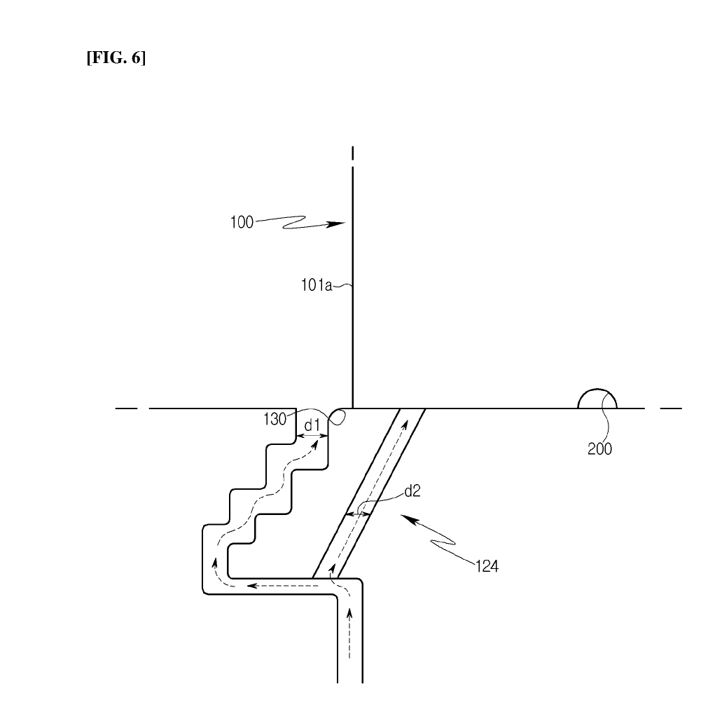

Referring to FIGS. 6 to 9, the second embodiment additionally includes a cooling channel 124 formed in the endwall 120 to supply cooling air to the leading edge 101a of the cooling object 100, separately from the cooling air of the airflow path 110. The present embodiment simultaneously achieves an additional supply of cooling air through the cooling channel 124 and improved movement stability of the supplied cooling air.

The cooling channel 124 communicates at one end (upstream) with the airflow path 110 and at the other end with the endwall 120. An inner diameter dl of the airflow path 110 may be present at the upstream end of the cooling channel 124, which has an inner diameter d2. The inner diameter d2 is greater than the inner diameter d1.

In this case, the cooling air can be more easily flowed into the inside of the cooling channel 124, and can be stably injected toward the endwall 120.

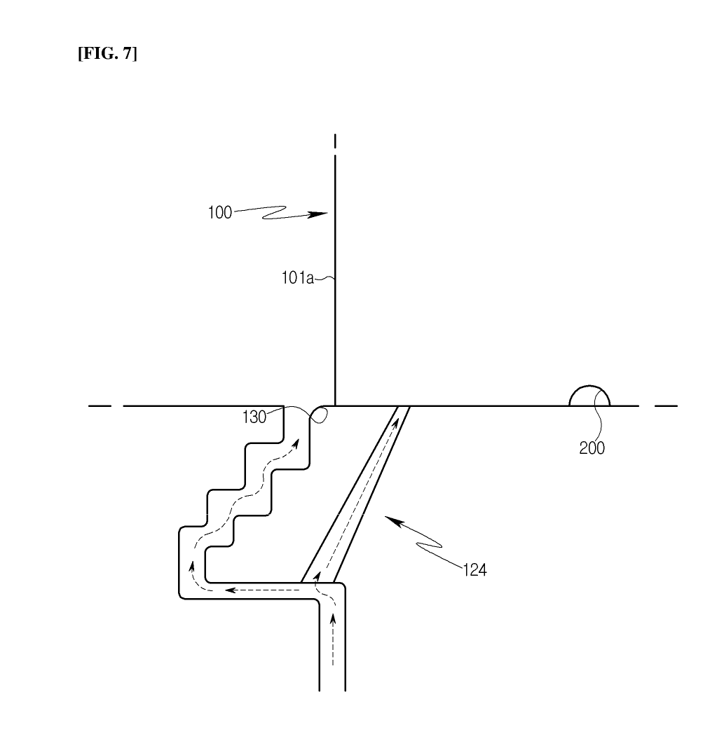

As shown in FIG. 7, the diameter of the cooling channel 124 may be reduced toward the endwall 120 from the airflow path 110. In this case, the cooling channel 124 can be used as a nozzle and the flow rate supplied to the cooling object 100 can be increased.

The cooling channel 124 includes an endwall end, toward the endwall 120, having a shape of either of a straight line and a curved line. Preferably, all of the above-described shapes are possible and are not specially limited to a specific shape.

However, when the operator processes the cooling channel 124, the straight line shape has the advantage of being easy to work.

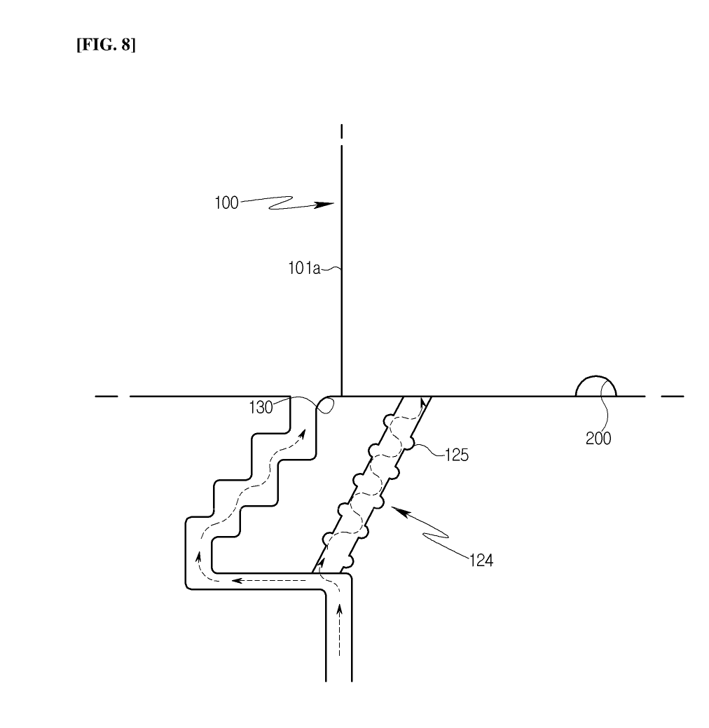

As shown in FIG. 8, the cooling channel 124 may include a groove portion 125 having a spiral shape formed on an inside surface of the cooling channel 124. The groove portion 125 can move the cooling air to the guide protrusion 200 with the minimized energy loss by providing the speed depending upon the movement of the cooling air.

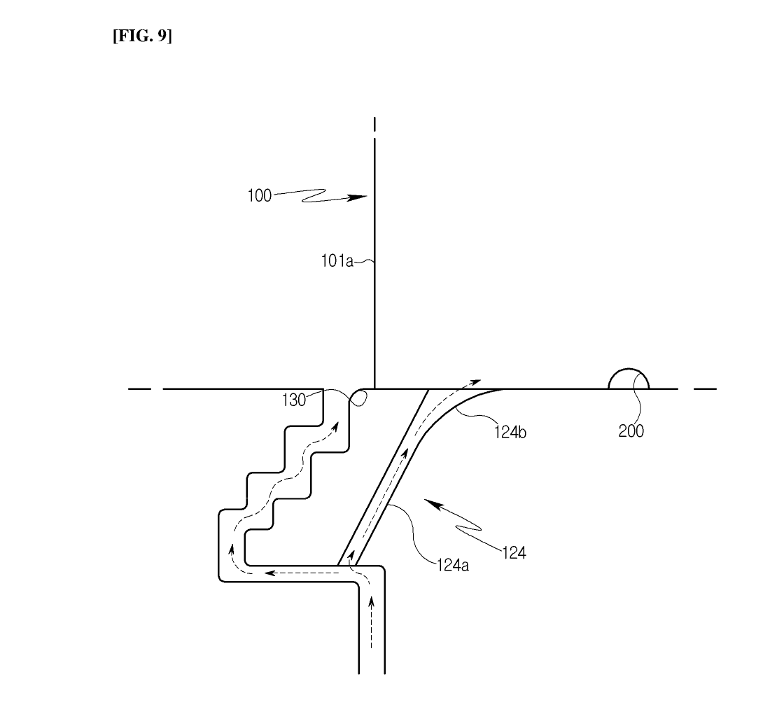

Referring to FIG. 9, the cooling channel 124 includes a first channel 124a extended to a first length, and a second channel 124b extended to be rounded toward the upper surface of the endwall 120 from the extended end portion of the first channel 124a.

The first channel 124a is extended longer than the second channel 124b, and the second channel 124b can adjust the echo into which the cooling air is injected to the intended location.

Accordingly, if the cooling air is injected through the second channel 124b, it stably moves along the surface of the endwall 120 and then moves toward the suction surface 103a and the pressure surface 103b of the cooling object 100 through the guide protrusion 200.

The guide protrusion 200 in accordance with the present embodiment is located adjacent to the suction surface 103a and the pressure surface 103b formed on the cooling object 100. The location corresponds to the optimum location where the cooling air is supplied to the surface of the cooling object 100 through the guide protrusion 200.

If the guide protrusion 200 is located away from the suction surface 103a and the pressure surface 103b, the movement of the cooling air to the surface of the cooling object 100 can be disadvantageous, such that the guide protrusion 200 is located at the above-described location.

While the present disclosure has been described with respect to the embodiment, it will be apparent to those skilled in the art that various changes and modifications may be made by adding, changing, or deleting components without departing from the spirit of the present disclosure as defined in the following claims, and included in the scope of the present disclosure.

What is claimed is:

1. A gas turbine, comprising:
an endwall supporting a cooling object and having an airflow path through which cooling air is supplied to a leading edge of the cooling object;
a curved portion disposed upstream of the leading edge to guide the cooling air supplied through the airflow path to the cooling object; and
a guide protrusion formed on an upper surface of the endwall to redirect the movement of the cooling air to a side surface of the cooling object.

2. The gas turbine of claim 1, wherein the cooling object includes either one of a vane and a blade provided in the gas turbine.

3. The gas turbine of claim 1, wherein the airflow path is inclined toward the cooling object.

4. The gas turbine of claim 1, wherein the curved portion has a lateral width greater than a lateral width of the cooling object.

5. The gas turbine of claim 1, wherein the curved portion includes a curve based on a first length and a second length, the second length corresponds to a vertical length extending from the upper surface of the endwall to a perpendicular extending from a first end of the curve, and the first length is greater than the second length and corresponds to a longitudinal length extending from the first end of the curve toward the cooling object and ending at a perpendicular extending from a second end of the curve.

6. The gas turbine of claim 1, wherein the guide protrusion is disposed in correspondence to a middle section between the leading edge and a trailing edge of the cooling object.

7. The gas turbine of claim 1, wherein the cooling object includes a suction surface and a pressure surface, and the guide protrusion is respectively disposed adjacent to the suction surface and the pressure surface.

8. The gas turbine of claim 7, wherein the guide protrusion is formed to have one of a hemispheric shape and a polygonal shape.

9. The gas turbine of claim 1, wherein the guide protrusion includes a protruded surface having a predetermined width and having a predetermined height protruding from the upper surface of the endwall.

10. The gas turbine of claim 1, wherein the endwall includes an air guiding surface disposed upstream of the guide protrusion and upwardly inclined toward the guide protrusion in order to guide the cooling air toward a crest of the guide protrusion.

11. The gas turbine of claim 1, wherein the cooling object includes a hub and a tip separated by a span (S), and the guide protrusion redirects the cooling air toward an S/2 location of the side surface of the cooling object.

12. A gas turbine, comprising:
an endwall supporting a cooling object and having an airflow path through which cooling air is supplied to a leading edge of the cooling object;
a curved portion disposed upstream of the leading edge to guide the cooling air supplied through the airflow path to the cooling object;
a guide protrusion formed on an upper surface of the endwall to redirect the movement of the cooling air to a side surface of the cooling object; and
a cooling channel formed in the endwall to supply cooling air to the leading edge of the cooling object, separately from the cooling air supplied through the airflow path.

13. The gas turbine of claim 12, wherein the cooling channel 124 has an inner diameter dl whose one end communicates with the airflow path 110 formed larger than an inner diameter d2 of the other end connected with the endwall 120.

14. The gas turbine of claim 12, wherein the cooling channel communicates at one end with the airflow path and at the other end with the endwall and has a diameter that is constant from the airflow path to the endwall.

15. The gas turbine of claim 12, wherein the cooling channel communicates at one end with the airflow path and at the other end with the endwall and has a diameter that is larger than a diameter of the airflow path.

16. The gas turbine of claim 12, wherein the cooling channel has a diameter that is reduced from the airflow path toward the endwall.

17. The gas turbine of claim 12, wherein the cooling channel includes an endwall end having a shape of either of a straight line and a curved line.

18. The gas turbine of claim 12, wherein the cooling channel includes a groove portion of a spiral shape formed on an inside surface.

19. The gas turbine of claim 12, wherein the cooling channel comprises:
a first channel having a first length; and
a second channel extending from the first channel and having a rounded end toward the upper surface of the endwall.

20. The gas turbine of claim 19, wherein the first channel is longer than the second channel.
